(19) United States
(12) Patent Application Publication
(10) Pub. No.: US 2012/0036310 A1
(43) Pub. Date: Feb. 9, 2012

(54) DATA PROCESSING DEVICE

(75) Inventors: Koichi NONAKA, Kanagawa (JP); Satoru Nakanishi, Kanagawa (JP)

(73) Assignee: RENESAS ELECTRONICS CORPORATION

(21) Appl. No.: 13/197,755

(22) Filed: Aug. 3, 2011

(30) Foreign Application Priority Data
Aug. 6, 2010 (JP) 2010-177434

(51) Int. Cl. G06F 12/02

(52) U.S. Cl. 711/103; 711/E12.008

(57) ABSTRACT

A data processing device is provided enabling faster read access to data in an on-chip EEPROM with relative ease, without increasing the area occupied by the chip and its power consumption. The on-chip nonvolatile memory included in the data processing device is provided with a pre-read cache which latches all or part of data, once having been read to bit lines from an array of nonvolatile memory cells by selecting a row address, and a selecting circuit which selects a portion of the data latched by the pre-read cache by selecting a portion of columns. Control is performed to retain address information for data latched by the pre-read cache, inhibit latching new data into the pre-read cache for read access to data in the nonvolatile memory according to the same address as the retained address information, and cause the selecting circuit to select the data latched by the pre-read cache.

### CROSS-REFERENCE TO RELATED APPLICATIONS

The disclosure of Japanese Patent Application No. 2010-177434 filed on Aug. 6, 2010 including the specification, drawings and abstract is incorporated herein by reference in its entirety.

### BACKGROUND

The present invention relates to a data processing device implemented as a semiconductor integrated circuit, including an electrically rewriteable and randomly accessible nonvolatile memory, and also relates to a technique that is effectively applied to, for example, single-chip microcomputers.

An EEPROM (Electrically Erasable Programmable Read Only Memory) is typical of an electrically rewriteable and randomly accessible nonvolatile memory. If, for example, the number of parallel bits carried by a data bus coupled to the EEPROM is two bytes, data rewriting in the EEPROM can be performed by erasing and writing data in units of two bytes or an integral multiple of two bytes.

As a technique enabling faster read access to data in this EEPROM, a cache memory that applies associative storage can be adopted.

As for an electrically rewriteable nonvolatile memory like a flash memory as a storage device having a large storage capacity, data rewriting is performed as follows: from a block to be erased, which is an erasable unit as large as, e.g., 256 bytes, data is read and latched into a sense latch and then the block is erased, followed by executing a logical OR operation or the like between the data saved in the sense latch and a few bytes of data to be written newly and writing the operation result data back into the erased block.

For the purpose of enabling faster read access to data in this flash memory, again, the cache memory can be applied similarly as above. Besides, other techniques for faster continuous read operation are provided, as described in Patent Documents 1 and 2. In these techniques, data, once having been read from nonvolatile memory cells, is buffered into a plurality of page buffers embodied by SRAM and the data buffered in the page buffers is output to outside.

### RELATED ART DOCUMENTS

### Patent Documents

### [Patent Document 1] Japanese Published Unexamined Patent Application No. 2005-285313

### [Patent Document 2] Japanese Published Unexamined Patent Application No. 2006-286179

### SUMMARY

However, it has been revealed by the present inventors that adopting the cache memory based on associative storage for faster read access to data in the EEPROM poses, inter alia, the following problems: the area occupied by the chip increases; power consumption increases; and, for a system that handles confidential data, a decrease in security is inevitable, because the confidential data is also held temporarily on a device different from the EEPROM. In a case where the page buffers as described in Patent Documents 1 and 2 are adopted with the EEPROM, the page buffers are added and relatively large logic components, namely, control logics for the page buffers also have to be added. Similarly as above, it has been revealed that the problems that the area occupied by the chip increases and power consumption increases still remain.

An object of the present invention is to provide a data processing device enabling faster read access to data in an on-chip EEPROM in a relatively easy manner, without increasing the area occupied by the chip as well as its power consumption.

The above-noted object and other objects and novel features of the present invention will become apparent from the description of the present specification and the accompanying drawings.

A typical aspect of the invention disclosed in this application is outlined as follows.

An on-chip nonvolatile memory included in a data processing device is provided with a pre-read cache which latches all or part of data, once having been read to bit lines from an array of nonvolatile memory cells by selecting a row address, and a selecting circuit which selects a portion of the data latched by the pre-read cache by selecting a portion of columns. Control is performed to temporarily retain address information for data latched by the pre-read cache, inhibit latching new data into the pre-read cache for read access to data in the nonvolatile memory according to the same address information as the retained address information, and cause the selecting circuit to select the data latched by the pre-read cache.

Since the above control may be implemented via a memory control circuit and controls latching data into the pre-read cache and outputting data, the control is relatively simple and there is no need for a large circuit size for the control logic. In addition, the logic circuit size of the pre-read cache to be added to the nonvolatile memory logic is large enough to allow for latching, at most, all data that has been once read to the bit lines by selecting a row address. An increase in the logic circuit size for the nonvolatile memory can be suppressed to a small extent.

Effect obtained by the typical aspect of the invention disclosed in the present application is outlined below.

Faster read access to data in an on-chip EEPROM can be implemented in a relatively easy manner, without increasing the area occupied by the chip as well as its power consumption.

### BRIEF DESCRIPTION OF THE DRAWINGS

FIG. 1 is a block diagram illustrating a microcomputer pertaining to an embodiment of the present invention;

FIG. 2 is a block diagram illustrating an EEPROM configuration;

FIG. 3 is a block diagram depicting an example of a memory controller;

FIG. 4 is an explanatory diagram illustrating the flow of a control signal from a timing generator to a pre-read cache.

FIG. 5 is a block diagram illustrating a pre-read cache configuration;

FIG. 6 is a timing chart illustrating an operation when performing a read access to data in a block whose address is different from a block address latched by an address latch;

FIG. 7 is a timing chart illustrating an operation when performing a read access to data in a block whose address is the same as the block address latched by the address latch;

FIG. 8 is a timing chart illustrating an operation of reading 8 bytes of data latched by the pre-read cache serially in units of two bytes and continuously from the pre-read cache to the system bus;

FIG. 9 is a timing chart illustrating an operation of reading a portion of 8 bytes of data latched by the pre-read cache, i.e., only data in the addresses of Am+4 and Am+6 from the pre-read cache to the system bus;

FIG. 10 is a timing chart illustrating an operation of reading 8 bytes of data latched by the pre-read cache in units of two bytes, but in different order from address order, from the pre-read cache to the system bus;

FIG. 11 is an explanatory diagram illustrating a manner of access to the EEPROM, when the CPU accesses the EEPROM and performs data processing;

FIG. 12 is a block diagram illustrating a data processing device adopting an EEPROM, additionally including a self-cache function;

FIG. 13 is a timing chart illustrating self-cache operation timing for the embodiment illustrated in FIG. 12; and

FIG. 14 is a block diagram of a data processing device adopting an EEPROM provided with a pre-read cache that latches data and program code separately.

### DETAILED DESCRIPTION

### 1. General Description of Embodiments

To begin with, exemplary embodiments of the invention disclosed herein are outlined. In the following general description of exemplary embodiments, reference designators in the drawings, which are given for referential purposes in parentheses, are only illustrative of elements that fall in the concepts of the components identified by the designators.

[1] <Pre-read cache and memory control logic> A data processing device (1) pertaining to an exemplary embodiment of the present invention includes, within a single semiconductor substrate, a central processing unit (5) which executes instructions, an electrically rewritable and randomly accessible nonvolatile memory (3), and a memory control logic (2, 2A, 2B) for implementing faster read access to data in the nonvolatile memory. The nonvolatile memory includes a pre-read cache (15, 15A, 15B) which latches all or part of data, once having been read to bit lines from an array of nonvolatile memory cells by selecting a row address, and a selecting circuit which selects a portion of the data latched by the pre-read cache by selecting a portion of columns. The memory control logic retains address information for the data latched by the pre-read cache, inhibits latching new data into the pre-read cache for read access to data in the nonvolatile memory according to the same address information as the retained address information, and causes the selecting circuit to select the data latched by the pre-read cache.

Since control that is implemented by the memory control logic controls latching data into the pre-read cache and outputting data, such control is relatively simple and there is no need for a large circuit size for the control logic. In addition, the logic circuit size of the pre-read cache to be added to the nonvolatile memory logic is large enough to allow for latching, at most, all data that has been once read to the bit lines by selecting a row address. An increase in the logic circuit size for the nonvolatile memory can be suppressed to a small extent.

[2] <Pre-read cache> In the data processing device as set forth in [1], the pre-read cache includes a sense latch circuit (32) which latches all or part of data, once having been read to the bit lines, an input gate circuit (30) placed at an input stage for the sense latch circuit, and an output gate circuit (31) placed at an output stage for the sense latch circuit

The pre-read cache is configured with the sense latch circuit and the gate circuits, so that its circuit size will be easy to reduce.

[3] <Encryption/decryption circuit> The data processing device as set forth in [2] further includes an encryption/decryption circuit (17) which encrypts write data to be input to the nonvolatile memory and written into nonvolatile memory cells and decrypts read data having been read from nonvolatile memory cells and to be output to outside.

In comparison to s system configuration in which a cache memory of associative storage type is provided external to the nonvolatile memory and decrypted confidential data is stored temporarily in the cache memory, a period during which confidential data is held externally to the nonvolatile memory becomes shorter and this can contribute to an improvement in security for confidential data.

[4] <Continuous self-cache> In the data processing device as set forth in [1], the pre-read cache (15A) includes a first sense latch circuit (42) which latches all or part of data, once having been read to the bit lines, a first input gate circuit (40) placed at an input stage for the first sense latch circuit, a first output gate circuit (44) placed at an output stage for the first sense latch circuit, a second sense latch circuit (43) which latches all or part of data, once having been read to the bit lines, a second input gate circuit (41) placed at an input stage for the second sense latch circuit, and a second output gate circuit (45) placed at an output stage for the second sense latch circuit. The memory control logic (2A) is equipped with an address counter which serially generates address information following the address information for the data latched by the pre-read cache during a reading operation. The memory control logic causes the first sense latch circuit and the second sense latch circuit to latch read data alternately, after having been read by selecting a row address, using address information which is serially generated by the address counter from an initial base value, and in parallel with a latching operation of read data into one sense latch circuit via one input gate circuit, the memory control logic causes data held by the other sense latch circuit to be output via the other output gate circuit to outside.

Thereby, it is possible to accomplish faster continuous read access to data in the nonvolatile memory, without imposing an additional load on the central processing unit.

[5] <Caching data and program code separately> In the data processing device as set forth in [1], the pre-read cache (15B) includes a first sense latch circuit (62) which latches all or part of data, once having been read to the bit lines, a first input gate circuit (60) placed at an input stage for the first sense latch circuit, a first output gate circuit (64) placed at an output stage for the first sense latch circuit, a second sense latch circuit (63) which latches all or part of data, once having been read to the bit lines, a second input gate circuit (61) placed at an input stage for the second sense latch circuit, and a second output gate circuit (65) placed at an output stage for the second sense latch circuit. The memory control logic (2B) retains address information for a program code latched by the pre-read cache during a program code reading operation, inhibits latching a new program code into the first sense latch circuit of the pre-read cache for read access to a program code in the nonvolatile memory according to the same address information as the retained address information for the program code, and generates a control signal causing the selecting circuit to select the program code latched by the pre-read cache. The memory control logic also retains address information for data latched by the pre-read cache during a data reading operation, inhibits latching new data into the second sense latch circuit of the pre-read cache for read access to data in the nonvolatile memory according to the same address information as the retained address information for the data, and causes the selecting circuit to select the data latched by the pre-read cache.

Thereby, the memory control logic can implement faster read access to both program code and data in the nonvolatile memory evenly and can accomplish this, without imposing an additional load on the central processing unit.

2. Details on Embodiments

Embodiments of the invention will now be described in greater detail.

### First Embodiment

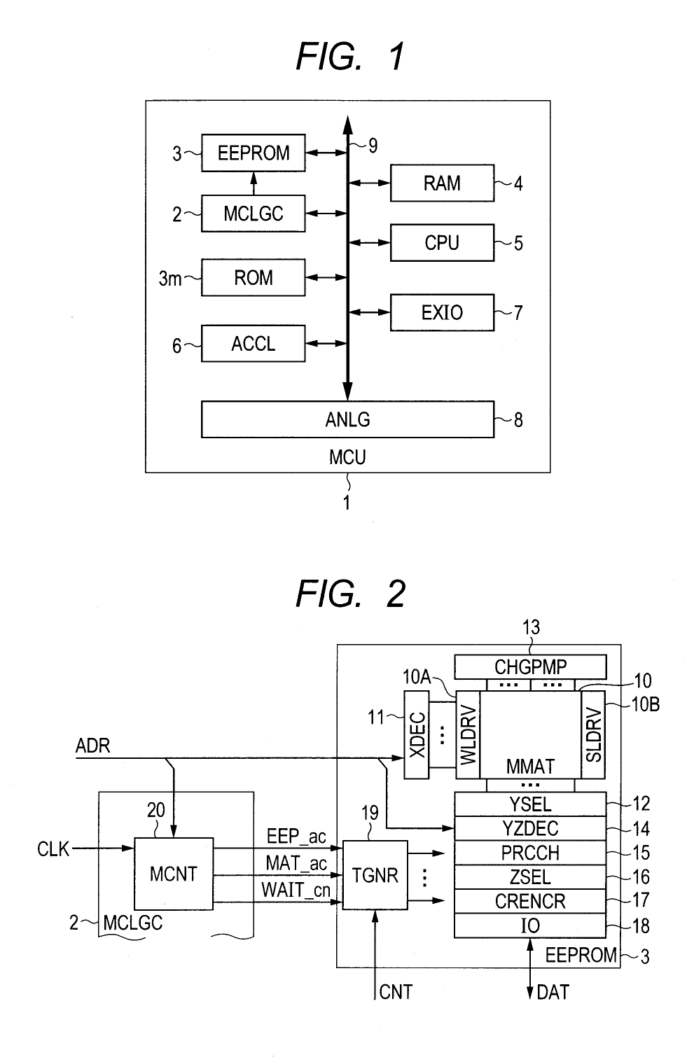

A microcomputer (microprocessor) pertaining to a first embodiment of the present invention is illustrated in FIG. 1. The microcomputer (MCU) 1 is an example of a data processing device (data processing system) pertaining to the present invention. Although not restrictive, it is formed over a single semiconductor substrate such as a monocrystalline silicon substrate by a CMOS integrated circuit manufacturing technology.

The microcomputer 1 includes a central processing unit (CPU) 5 which executes a program, a RAM 4 as a working memory which is used as a working area or the like for the CPU 5, an accelerator (ACCL) 6 which undertakes a part of processing tasks of the CPU 5, a ROM 3m like a mask ROM which is an electrically non-rewritable nonvolatile memory for storing programs or the like which are executed by the CPU 5, an EEPROM 3 as a nonvolatile memory which stores data or the like for use in data processing by the CPU 5 in an electrically rewritable manner, a memory control logic (MCLGC) 2 which controls a pre-read cache function of the EEPROM 3, external input/output circuit (EXIO) 7, and an analog circuit (ANGLG) 8, each of these components being coupled to a system bus 9.

Although not restrictive, the microcomputer 1 is the one that is applied to an IC card microcomputer and is used for, inter alia, authentication processing using confidential data; for example, it is applied for authentication of a user of a mobile phone and authentication of a user of an IC card.

A configuration of the EEPROM 3 is illustrated in FIG. 2. The EEPROM 3 includes a memory mat (MMAT) 10 having nonvolatile memory cells arranged in an array and these memory cells are rewritable by an electrically erasing and writing operation. Although not restrictive, a nonvolatile memory cell is comprised of a MOS-type memory transistor for storing information in a p-type well region provided over the silicon substrate and a MOS-type selecting transistor to select the memory transistor. The memory transistor includes an n-type diffusion layer (n-type impurity region) as a source line coupled electrode which is coupled to a source line, a charge storing insulating film (e.g., a silicon nitride film), insulating films (e.g., oxide silicon films) overlying and underlying the charge storing insulating film, and a memory gate electrode (e.g. n-type polysilicon layer) for high voltage application during a data write or erasure. The selecting transistor includes an n-type diffusion layer (n-type impurity region) as a bit line coupled electrode which is coupled to a bit line, a gate insulating film (e.g., an oxide silicon film), a control gate electrode (e.g., an n-type polysilicon layer), and an insulating film (e.g., an oxide silicon film) which provides insulation between the control gate electrode and a memory gate electrode. For example, erasing a nonvolatile memory cell is performed by discharging electrons from the charge storing insulating film and writing is performed by charging the charge storing insulating film with electrons. Details about this type of memory cells are found in WO publication No. WO 2003/012878.

Word lines which are coupled to the selecting terminals of the nonvolatile memory cells are driven by a select signal which is output from an X decoder (XDEC) 11 which generates a select signal by decoding an address signal ADR. Source lines are driven by a select signal which is output from the X decoder (XDEC) 11. A voltage for driving bit lines, source lines, and word lines is provided by a high voltage which is produced by a charge pump circuit (CHGPMP) 13. Bit lines are selected by a Y selector (YSEL) 12 and this selection is made by a Y select signal which is generated by decoding an address signal ADR by an YZ decoder (YZDEC) 14. Here, although not restrictive, memory cells to be selected by a word line are assumed to be 64 bytes wide. The Y selector 12 selects 8 bytes from the 64 bytes.

8 bytes of read data selected by the Y selector 12 are temporarily cached in a pre-read cache (PRCCH) 15. From the 8 bytes of read data cached in the pre-read cache (PRCCH) 15, for example, 2 bytes re selected by a Z selector (ZSEL) 16. This selection is made by a Z select signal which is generated by decoding an address signal ADR by an YZ decoder 14. Here, the address signal ADR includes an X address signal for generating word line and source line selecting signals by the X decoder 11, a Y address signal for generating a Y select signal, and a Z address signal for generating a Z select signal. The read data selected by the Z selector 16 is decrypted by an encryption/decryption circuit (CRENCR) 17 and output to the system bus 9 from an input/output circuit (10) 18. DAT denotes data on the system bus 9.

2 bytes of write data passed from the system bus 9 to the input/output circuit 18 are encrypted by the encryption/decryption circuit 17. The encrypted 2 bytes of write data are passed to bit lines selected via the Z selector 16 and the Y selector 12 and written into memory cells on a word line selected at that moment. Although not shown particularly, it is assumed that data erasure to be done before writing is performed in units of 8 bytes which are defined as erasable blocks. The following process is performed: latching data from a block to be erased before erasing it, executing a logical OR operation between the latched 8 bytes of data and 2 bytes of write data, and writing the result data back into the erased block of 8 bytes. In a case that data erasure is also performed in units of two bytes, it is not needed to execute a logical OR operation between latched data and write data.

Generating internal timing for a read operation, an erasure operation, and a write operation is performed by a timing generator (TGNR) 19. The timing generator 19 receives an access control signal CNT from the system bus 9 and also receives control signals EEP_ac, CCH_ac, and WAIT_cn for pre-read cache operation from a memory controller (MCNT) 20.

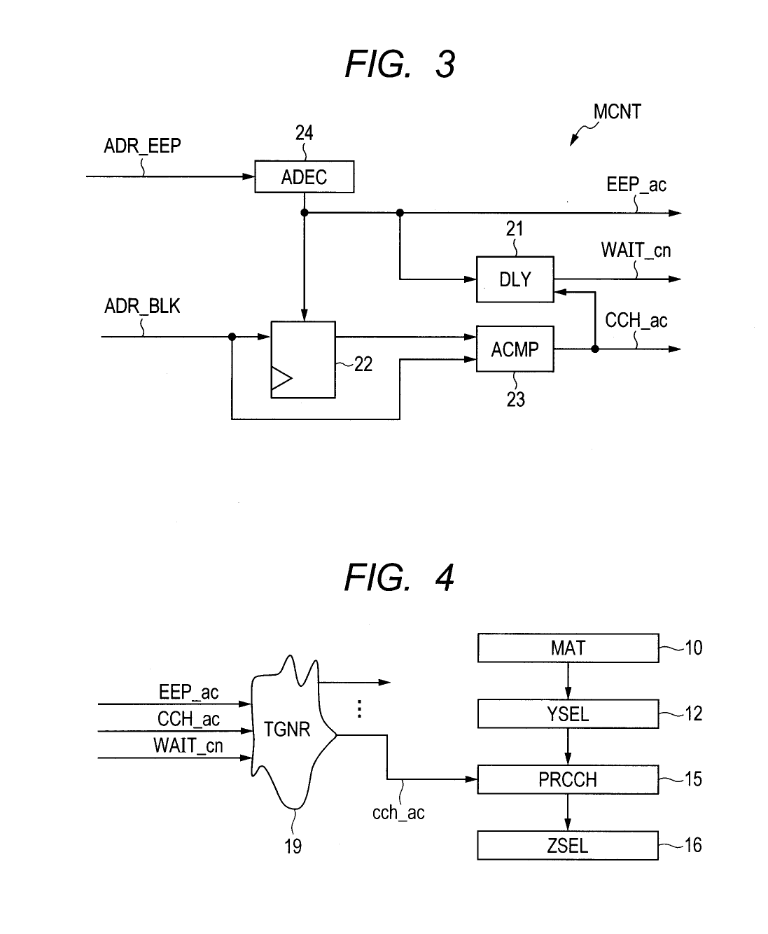

An example of the memory controller 20 is shown in FIG. 3. The memory controller 20 includes a delay circuit (DLY) 21, an address latch circuit 22, an address comparison circuit (ACMP) 23, and an address decoder (ADEC) 24. The address decoder 24 decodes an upper portion (ADR_EEP) of an address signal ADR and determines whether access to the EEPROM is selected. Upon detecting an EEPROM access request, the control signal EEP_ac is turned to a low level. Although not restrictive, a low level duration of the control signal EEP_ac is assumed to correspond to one cycle of a clock signal CLK. The address latch circuit 22 latches the address (ADR_BLK) of a data block, once the control signal EEP_ac has been asserted low. Here, a data block is assumed to have 8 bytes in size and this size corresponds to a data size to be latched by the pre-read cache 15. The address (ADR_BLK) of a data block is a part of the address signal ADR. According to this embodiment, if least significant bits of the address signal ADR are assumed to indicate a byte address, the address of a data block is indicated by the remaining part of the address signal ADR other than three least significant bits. The address comparison circuit 23 compares a new address signal ADR_BLK supplied from the system bus 9 according to an access cycle with the address signal already latched in the address latch circuit 22 and outputs the comparison result as the control signal CCH_ac. It outputs a low level when a comparison match occurs and a high level when a comparison mismatch occurs. When the control signal CCH_ac is at a high level, it means that the new address signal ADR_BLK indicates the same block address as the lathed address signal. In other words, the new address signal indicates the same block address as the address of the block of 8 bytes of data held in the pre-read cache 15. The delay circuit 21 changes the control signal WAIT_cn to remain at a low level for a number of cycles to be inserted as wait cycles, provided that the control signal CCH_ac is high level at the time of a rising edge of the control signal EEP_ac. Here, it is assumed that the number of cycles to be inserted as the wait cycles is two cycles of the clock signal CLK, three cycles are needed to read data from the memory mat 10 to the system bus 9, and only one cycle is needed to read data from the pre-read cache 15 to the system bus 9.

The flow of a control signal from the timing generator 19 to the pre-read cache 15 is illustrated in FIG. 4. Upon receiving the above control signals EEP_ac, CCH_ac, and WAIT_cn, the timing generator 19 outputs a control signal cch_ac to the pre-read cache 15.

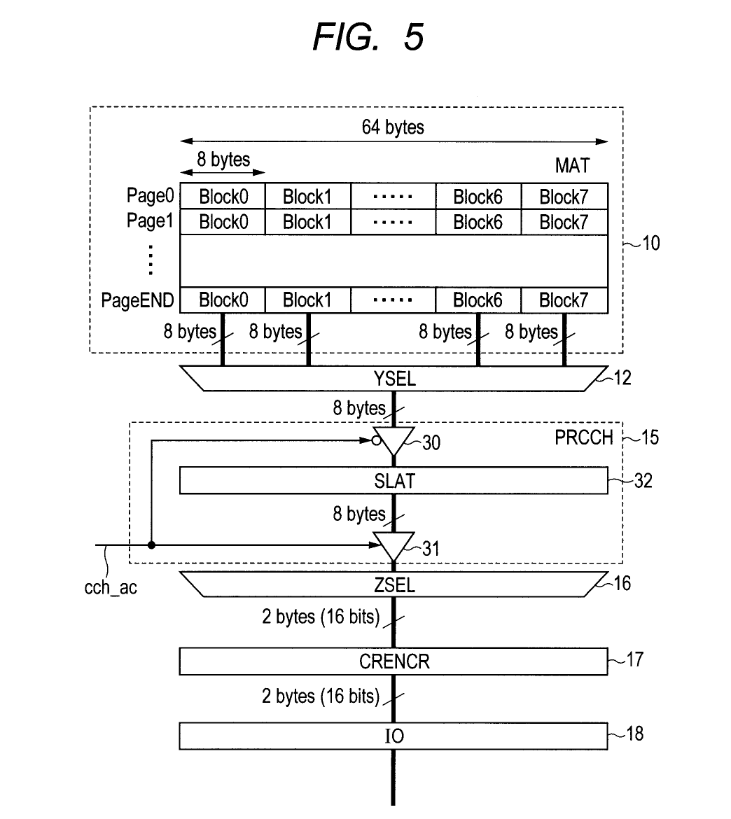

A configuration of the pre-read cache 15 is illustrated in FIG. 5. The pre-read cache 15 includes a sense latch circuit (SLAT) 32 which latches 8 bytes of data selected by the Y selector 12, an input gate circuit 30 placed at an input stage for the sense latch circuit 32, and an output gate circuit 31 placed at an output stage for the sense latch circuit 32. Input/output operations of the input gate circuit 30 and the output gate circuit 31 are controlled in a complementary fashion by a timing control signal cch_ac. When this signal is high level, the input/output operation of the input gate circuit 30 is enabled, whereas the input/output operation of the output gate circuit 31 is disabled; they are controlled inversely to this, when the signal is low level.

In FIG. 5, the structure of the memory mat 10 is also illustrated, in which one page is comprised of 8 blocks and one block is comprised of 8 bytes.

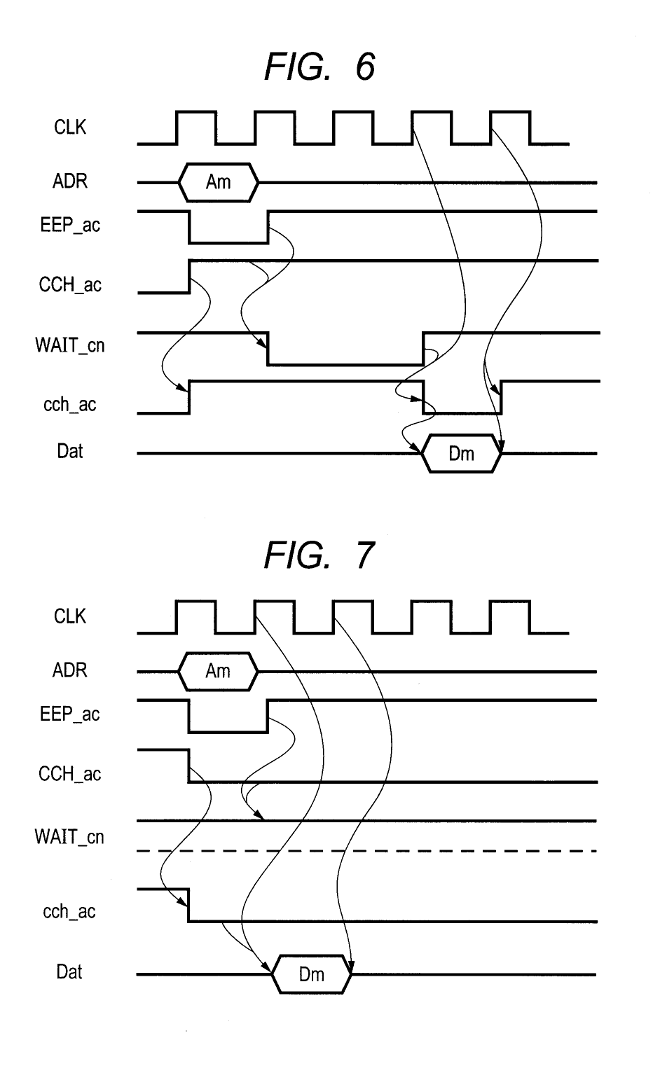

FIG. 6 illustrates an operation timing chart when performing a read access to data in a block whose address is different from a block address latched by the address latch 22. When a different block address Am is supplied, the control signal CCH_ac is inverted to the high level. In response to this, the timing signal cch_ac is inverted to the high level, which enables the input/output operation of the input gate 30 and disables the input/output operation of the output gate 31. In synchronization with the rising of the control signal EEP_ac, the control signal WAIT_cn is turned to be low during two cycles only. As a result, two wait cycles are inserted in the timing generator 19. During these cycles, 8 bytes of read data, once having been read from the memory mat 10, are latched by the pre-read cache 15. During only one clock cycle as the next clock cycle of the clock signal CLK, the timing signal cch_ac is turned to be low. As a result, from the 8 bytes of read data latched by the pre-read cache 15, two bytes are selected by the Z selector 16 and the selected data DAT is output to the system bus 9.

FIG. 7 illustrates an operation timing chart when performing a read access to data in a block whose address is the same as the block address latched by the address latch 22. Subsequently to the timing chart of FIG. 6, when the same block address Am as the already latched block address is supplied, the control signal CCH_ac is inverted to the low level. In response to this, the timing signal cch_ac is inverted to the low level, which disables the input/output operation of the input gate 30 and enables the input/output operation of the output gate 31. Because the control signal CCH_ac is low level, no instruction is made to insert wait cycles by the control signal WAIT_cn, even when the control signal EEP_ac rises. The timing generator 19 causes the Z selector 16 to select two bytes from the 8 bytes of read data already latched by the pre-read cache 15 during the next one cycle of the clock signal CLK and the selected data DAT is output to the system bus 9.

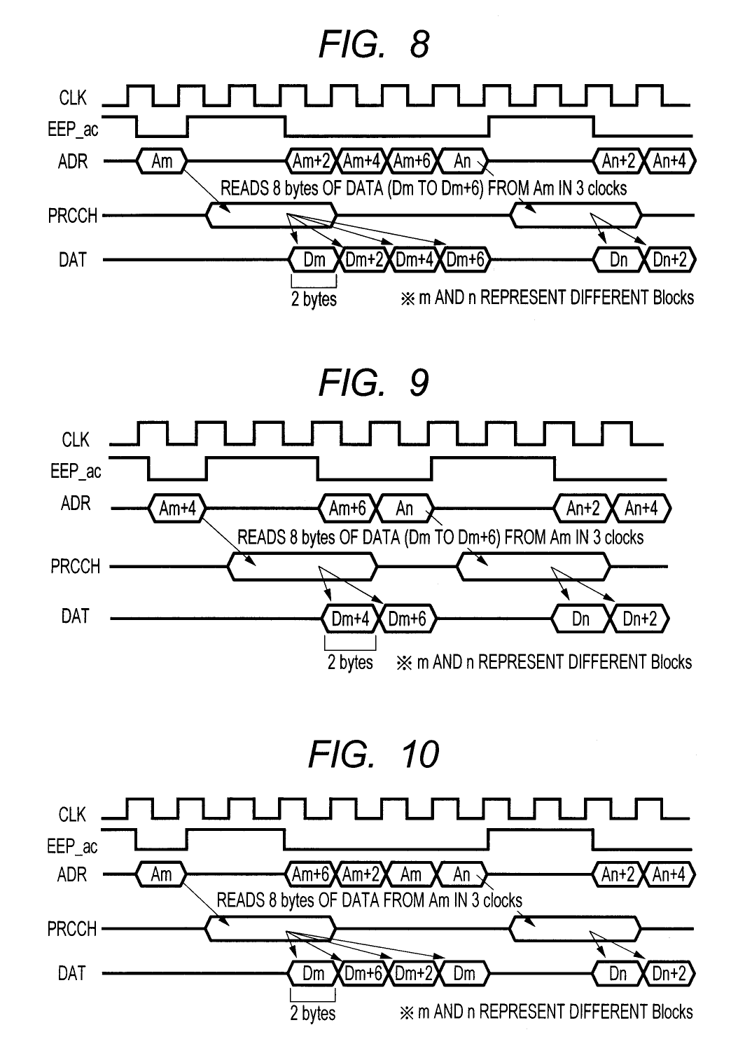

FIGS. 8 through 10 illustrate some manners of reading the 8 bytes of read data latched by the pre-read cache 15.

In FIG. 8, the 8 bytes of data lathed by the pre-read cache 15 are read serially in units of two bytes and continuously from the pre-read cache 15 to the system bus 9. When a read access to another block address An has occurred, the data held in the pre-read cache 15 is replaced by data in the block with the block address An.

In FIG. 9, a portion of the 8 bytes of data latched by the pre-read cache 15, i.e., data in the addresses of Am+4 and Am+6 is only read from the pre-read cache 15 to the system bus 9. When a read access to a different block address An has occurred, the data held in the pre-read cache 15 is replaced by data in the block with the block address An.

In FIG. 10, the 8 bytes of data lathed by the pre-read cache 15 are read in units of two bytes, but in different order from address order, from the pre-read cache 15 to the system bus 9. Like this, it is possible to read data from the pre-read cache 15 in appropriate order, not in address order, which can be set flexibly within the range of the data held in the pre-read cache 15.

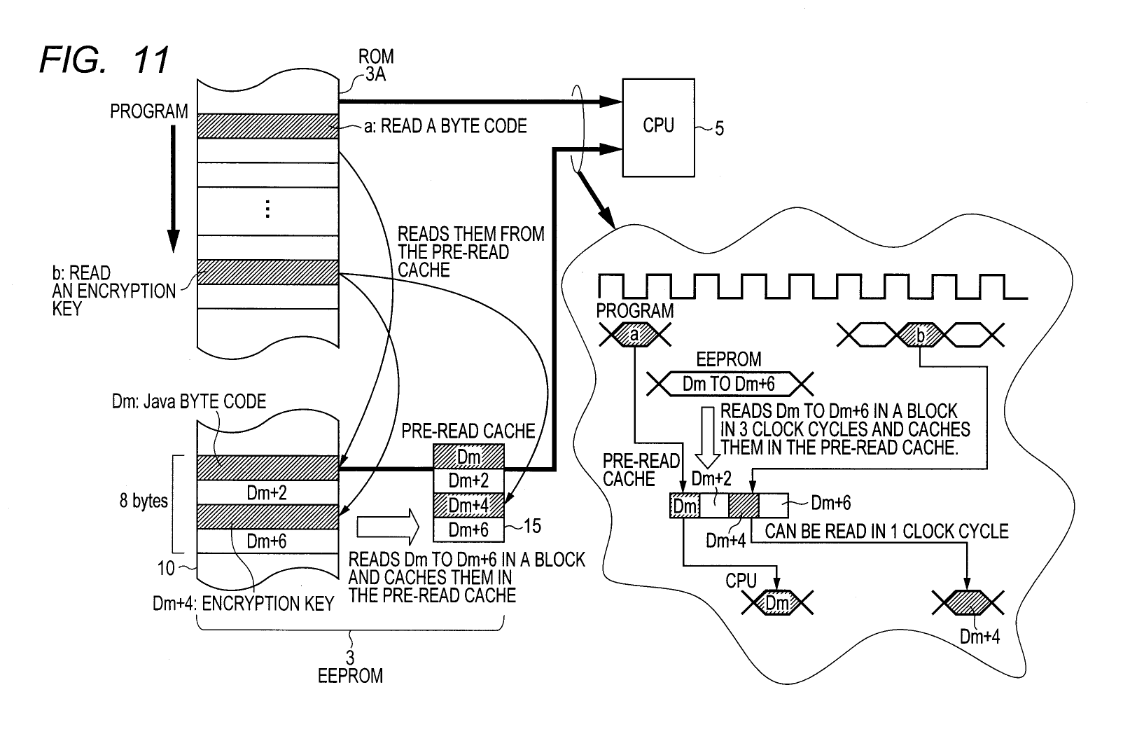

FIG. 11 illustrates a manner of access to the EEPROM, when the CPU 5 accesses the EEPROM and performs data processing. For example, suppose that the CPU executes a program stored in the ROM 3m and the processing involves reading a byte code and an encryption key which are shown representatively. Data needed to perform the processing is stored in the EEPROM 3. If, for example, the byte code is stored in an address of Dm and the encryption key is stored in an address Dm+4, both the byte code and the encryption key are included in a same block address . Accordingly, following the byte code reading, it is possible to read the encryption key in one cycle of the clock signal CLK from the pre-read cache 15.

The microcomputer described in the foregoing first embodiment provides the following positive effects.

(1) <Pre-read cache and memory control logic> The pre-read cache function for the EEPROM 3 controls a data latch operation or a data output operation for the pre-read cache 15. Such control is relatively simple and there is no need for a large circuit size for the control logic. In addition, the logic circuit size of the pre-read cache to be added is large enough to allow for latching, at most, all data that has been once read to the bit lines by selecting a row address. An increase in the pre-read cache circuit size can be suppressed to a small extent relative to the whole EEPROM logic circuit size. Accordingly, it is possible to enable faster read access to data in the on-chip EEPROM in a relatively easy manner, without increasing the area occupied by the chip as well as its power consumption.

(2) <Pre-read cache> The pre-read cache 15 is configured with the sense latch circuit 32 and the gate circuits 30, 31, so that its circuit size will be easy to reduce.

(3) <Encryption/decryption circuit> In comparison to s system configuration in which a cache memory of associative storage type is provided external to the EEPROM and decrypted confidential data is stored temporarily in the cache memory, a period during which confidential data is held externally to the EEPROM becomes shorter and this can contribute to an improvement in security for confidential data.

### Second Embodiment

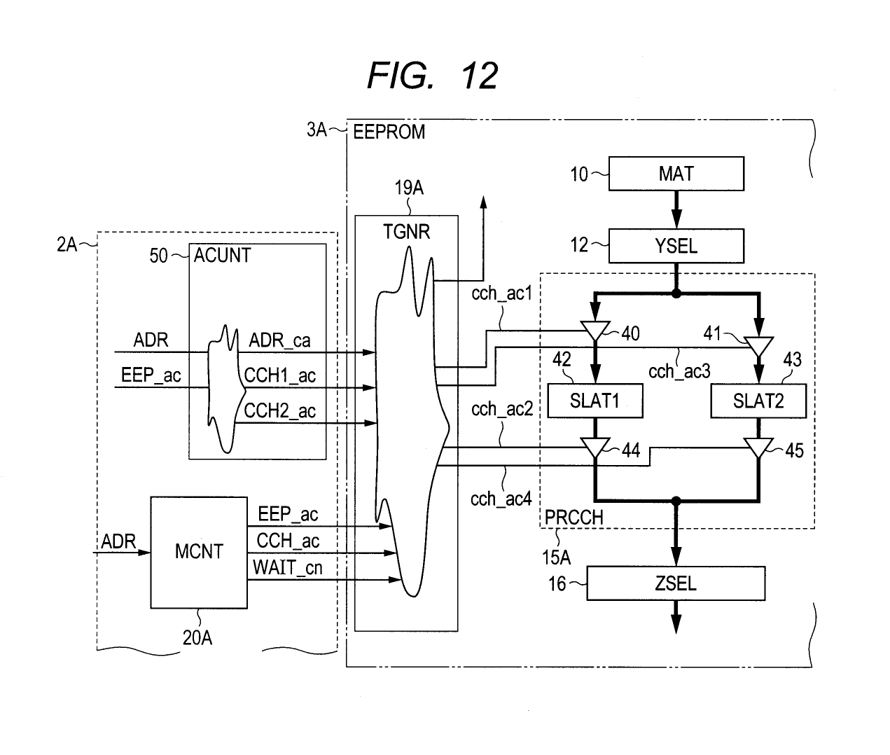

A data processing device adopting an EEPROM, additionally including a self-cache function for continuous reading, is illustrated in FIG. 12. Here, the EEPROM with a pre-read cache provided with two sense latches is shown. The pre-read cache 15A is configured to have two banks of sense latches and the self-cache function enables a continuous read operation without interruption by way of, after storing 8 bytes of read data into one sense latch, pre-reading next 8 bytes of data in advance to the other sense latch.

In contrast to the configuration illustrated in FIGS. 2 through 5, the pre-read cache 15A includes a first sense latch circuit (SLAT1) 42 which lathes 8 bytes of data selected by the Y selector 12, a first input gate circuit 40 placed at an input stage for the first sense latch circuit 42, a first output gate circuit 44 placed at an output stage for the first sense latch circuit 42, a second sense latch circuit 43 which latches 8 bytes of data selected by the Y selector 12, a second input gate circuit 41 placed at an input stage for the second sense latch circuit 43, and a second output gate circuit 45 placed at an output stage for the second sense latch circuit 43.

Input/output operations of the input gate circuit 40 and the output gate circuit 44 are controlled by timing control signals cch_ac1, cch_ac2. Input/output operations of the input gate circuit 41 and the output gate circuit 45 are controlled in a complementary fashion by timing control signals cch_ac3, cch_ac4.

A memory control logic 2A is equipped with an address counter (ACUNT) 50, besides a memory controller 20A. The memory controller 20A is equipped with two address latch circuits 22 which are used alternately, switched from one to another every four cycles of the clock signal CLK. The address counter 50 generates a pre-read address ADR_ca by incrementing a block address signal ADR_BLK every three cycles of the clock signal CLK and turns cache input timing signals CCH1_ac and CCH2_ac to a select level alternately for each increment.

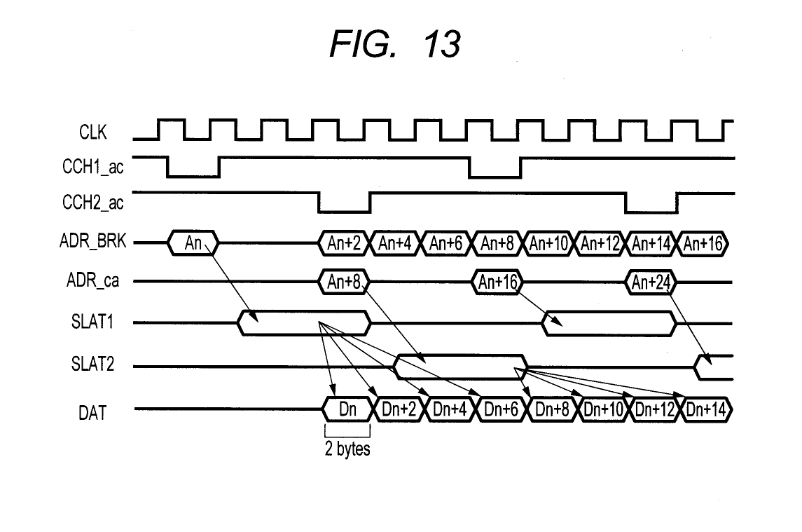

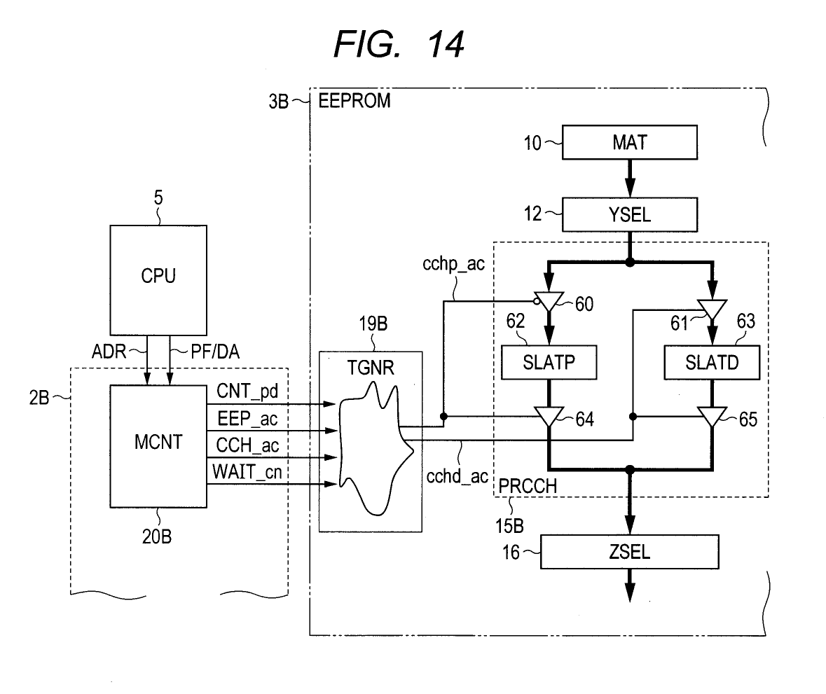

A timing generator 19A includes a logic that takes input of the control signals ADR_ca, CCH1_ac, CCH2_ac, EEP_ac, CCH_ac, and WAIT_cn and generates timing signals cch_ac1, cch_ac2, cch_ac3, and cch_ac4. Although not restrictive, this logic is configured to satisfy the operation timing as illustrated in FIG. 13. In other words, the logic of the timing generator 19A causes the first sense latch circuit 42 and the second sense latch circuit 43 to latch read data alternately, using addresses ADR_ca which are serially generated by the address counter 50 from an initial base value. In parallel with a latching operation of read data into one sense latch circuit 42 (43) via one input gate circuit 40 (41), the logic also causes data held by the other sense latch circuit 43 (42) to be output via the other output gate circuit 45 (44) to outside. The logic of the timing generator 19A performs the same control as in the configuration illustrated in FIGS. 2 through 5, when the self-cache mode is not specified.

According to the second embodiment, it is possible to accomplish faster continuous read access to data in the EEPROM 3A, without imposing an additional load on the CPU 5.

### Third Embodiment

A data processing device adopting an EEPROM including a pre-read cache 15B that latches data and program code separately is illustrated in FIG. 14. The pre-read cache 15B includes a first sense latch circuit (SLATP) 62 which lathes 8 bytes of program code selected by the Y selector 12, a first input gate circuit 60 placed at an input stage for the first sense latch circuit 62, a first output gate circuit 64 placed at an output stage for the first sense latch circuit 62, a second sense latch circuit (SLATD) 63 which latches 8 bytes of data selected by the Y selector 12, a second input gate circuit 61 placed at an input stage for the second sense latch circuit 63, and a second output gate circuit 65 placed at an output stage for the second sense latch circuit 63.

A memory control logic 2B includes a memory controller 20B and this memory controller 20B additionally includes a function to output a control signal CNT_pd in response to an access strobe signal PF/DA which is output by the CPU 5; this function is added to the memory controller 20 described in the first embodiment. The CPU 5 outputs an access strobe signal PF/DA which is turned to be high level for fetching program code and low level for access to data. Although not restrictive, the control signal CNT_ad is assumed to have the same logic value as the access strobe signal PF/DA. The memory controller 20B supplies the control signal CNT_ad as well as the same control signals EEP_ac, CCH_ac, and WAIT_cn as those that are output by the foregoing memory controller 20 to the timing generator 19B. For fetching program code, the timing generator 19B controls the input gate circuit 60 and the output gate circuit 64, using a timing control signal cchp_ac in the same way as done by the timing signal cch_ac in the first embodiment. For access to data, the timing generator 19B controls the input gate circuit 61 and the output gate circuit 65, using a timing control signal cchd_ac in the same way as done by the timing signal cch_ac in the first embodiment. In other words, the memory controller retains program code address information during a program code reading operation, inhibits latching a new program code into the first sense latch circuit 62 of the pre-read cache 15B for read access to a program code in the EEPROM 3B according to the same address information as the retained program code address information, and causes the Z selector 16 to select the program code latched by the pre-read cache 15B. Likewise, the memory controller retains data address information at the instant of reading data, inhibits latching new data into the second sense latch circuit 63 of the pre-read cache 15B for read access to data in the EEPROM 3B according to the same address information as the retained data address information, and causes the Z selector 16 to select the data latched by the pre-read cache 15B.

Thereby, faster read access to both program code and data in the EEPROM 3B can be carried out evenly.

While the invention made by the present inventors has been described specifically based on its embodiments hereinbefore, it will be appreciated that the present invention is not limited to the described embodiments and a variety of modifications may be made without departing from the scope of the invention.

For example, circuit modules that are installed in the microcomputer are not limited to those described in the foregoing embodiments and may be modified as appropriate. The microcomputer is not limited to a microcomputer for IC cards and the invention is widely applicable to microcomputers which can be embedded in various types of equipment and devices.

The arrangement for selecting a portion of columns is not limited to the arrangement using the Y selector and the Z selector. Data that is stored in the pre-read cache is not limited to 8 bytes. The pre-read cache may have a capacity to store all data, once having been read to the bit lines by selecting a word line, for example, 64 bytes of data in accordance with FIG. 1. In this case, in the following stage for the pre-read cache, a Y selector to select two bytes from 64 bytes may preferably be installed.

It may be dispensable that the nonvolatile memory is equipped with the encryption/decryption circuit.

What is claimed is:

1. A data processing device comprising a single semiconductor substrate,
the semiconductor substrate comprising:
a central processing unit which executes instructions;
an electrically rewritable and randomly accessible nonvolatile memory; and
a memory control logic for implementing faster read access to data in the nonvolatile memory,
wherein the nonvolatile memory comprises a pre-read cache which latches all or part of data, once having been read to bit lines from an array of nonvolatile memory cells by selecting a row address, and a selecting circuit which selects a portion of the data latched by the pre-read cache by selecting a portion of columns, and
wherein the memory control logic retains address information for the data latched by the pre-read cache, inhibits latching new data into the pre-read cache for read access to data in the nonvolatile memory according to the same address information as the retained address information, and causes the selecting circuit to select the data latched by the pre-read cache.

2. The data processing device according to claim 1, wherein the pre-read cache comprises a sense latch circuit which latches all or part of data, once having been read to the bit lines, an input gate circuit placed at an input stage for the sense latch circuit, and an output gate circuit placed at an output stage for the sense latch circuit.

3. The data processing device according to claim 2, further comprising an encryption/decryption circuit which encrypts write data to be input to the nonvolatile memory and written into nonvolatile memory cells and decrypts read data having been read from nonvolatile memory cells and to be output to outside.

4. The data processing device according to claim 1,
wherein the pre-read cache comprises a first sense latch circuit which latches all or part of data, once having been read to the bit lines, a first input gate circuit placed at an input stage for the first sense latch circuit, a first output gate circuit placed at an output stage for the first sense latch circuit, a second sense latch circuit which latches all or part of data, once having been read to the bit lines, a second input gate circuit placed at an input stage for the second sense latch circuit, and a second output gate circuit placed at an output stage for the second sense latch circuit, and
wherein the memory control logic is equipped with an address counter which serially generates address information following the address information for the data latched by the pre-read cache during a reading operation, the memory control logic causes the first sense latch circuit and the second sense latch circuit to latch read data alternately, after having been read by selecting a row address, using address information which is serially generated by the address counter from an initial base value, and in parallel with a latching operation of read data into one sense latch circuit via one input gate circuit, the memory control logic causes data held by the other sense latch circuit to be output via the other output gate circuit to outside.

5. The data processing device according to claim 1,
wherein the pre-read cache comprises a first sense latch circuit which latches all or part of data, once having been read to the bit lines, a first input gate circuit placed at an input stage for the first sense latch circuit, a first output gate circuit placed at an output stage for the first sense latch circuit, a second sense latch circuit which latches all or part of data, once having been read to the bit lines, a second input gate circuit placed at an input stage for the second sense latch circuit, and a second output gate circuit placed at an output stage for the second sense latch circuit, and
wherein the memory control logic retains address information for a program code latched by the pre-read cache during a program code reading operation, inhibits latching a new program code into the first sense latch circuit of the pre-read cache for read access to a program code in the nonvolatile memory according to the same address information as the retained address information for the program code, and generates a control signal causing the selecting circuit to select the program code latched by the pre-read cache, and the memory control logic also retains address information for data latched by the pre-read cache during a data reading operation, inhibits latching new data into the second sense latch circuit of the pre-read cache for read access to data in the nonvolatile memory according to the same address information as the retained address information for the data, and causes the selecting circuit to select the data latched by the pre-read cache.
